(19) United States
(12) Patent Application Publication
(10) Pub. No.: US 2010/0262580 A1
(43) Pub. Date: Oct. 14, 2010

(54) DATA SYNCHRONIZING SYSTEM AND METHOD USING XRI DATA LINK

(75) Inventors: Youngseob Cho, Daejeon (KR); Sangrae Cho, Daejeon (KR); Daeseon Choi, Daejeon (KR); Jonghyouk Noh, Daejeon (KR); Soohyung Kim, Daejeon (KR); Seunghyun Kim, Daejeon (KR); Seunghun Jin, Daejeon (KR)

Correspondence Address: AMPACC Law Group, 3500 188th Street S.W., Suite 103, Lynnwood, WA, 98037, US

(73) Assignee: Electrics and Telecommunications Research Institute, Daejeon (KR)

(21) Appl. No.: 12/745,734

(22) PCT Filed: Aug. 28, 2008
(86) PCT No.: PCT/KR2008/005036

§ 371 Date: Jun. 2, 2010

(30) Foreign Application Priority Data
Dec. 4, 2007 (KR) 10-2007-0124803

(51) Int. Cl. G06F 17/30

(52) U.S. Cl. 707/610; 707/E17.005; 707/E17.014; 707/769

(57) ABSTRACT

The present invention relates to a data synchronizing system and method using an XRI data link. The data synchronizing system includes a user data provider, a user data consumer, and an XRI resolver that analyzes received XRI identifiers and rovides metadata related to the XRI identifiers. The user data provider instructs the user data consumer to update data using the metadata related to the XRI identifiers, and provides a data synchronizing function, which has been provided in the form of a Web service, through the XRI data link. As a result, an application program can facilitate data synchronization, and thus the efficiency of a system can be improved.

### TECHNICAL FIELD

The present invention relates to a data synchronizing system and method using an XRI data link, and more particularly, to a data synchronizing system and method using an XRI data link that synchronizes data using data connection information as an extensible resource identifier XRI, which has been developed to improve an URI in which a link is likely to be broken due to a change in configuration and a change in server.

This work was supported by the IT R&D program of MIC/IITA [2007-S-601-01, User Control Enhanced Digital Identity Wallet System].

### BACKGROUND ART

In recent years, URIs (uniform resource identifiers) have been commonly used as resource identifiers. However, when the resource identified by the URI is modified due to the movement or combination of organizations, connection between the organizations is not continued. This is because information on the physical position of the resource is included in the URI.

When the URI is used to indicate a specific resource, an expression, such as, “http://www.company.com/dept1/A.doc” is used to identify a document “A.doc” that is managed by a department “dept1” in a “company”. However, if departments of the company are unified and the department “dept1” is changed to a department “IntegratedDept”, a URI for the same document is generally changed to “http://www.company.com/IntegratedDept/A.doc”. In this case, since the existing URIs, which have been used before the unification of departments, do not identify new documents, links are broken. A separate program should be executed in order to maintain these links. This problem occurs since the URI syntax has no measures for the movement of resources.

As an example of the existing techniques for using URIs to provide a Web service, the following technique has been proposed: when a user data provider IdP changes user data, in order to reflect the changed data to a user data consumer IdC, a directory server searches information on the user data consumer, and calls a Web service. However, in this case, since all system information items use the existing URIs, no service is provided during the movement of the system. In addition, since the representation of the changed data differs from the representation of the user data consumer receiving a synchronizing service, there are difficulties in managing the data.

In order to solve these problems, an XRI (extensible resource identifier), which is an abstract identifier, has been developed. The XRI does not include information on the physical position of resources, but provides only abstract information. In the above-mentioned example, when the XRI is used, resources are represented by “@company/dept/A.doc”. When the actual document indicated by the XRI identifier is searched, each XRI element is mapped to concrete URI information. Therefore, even when departments are changed or the physical positions of resources are changed, it is only necessary to maintain mapping information for the change in information.

The XRI identifier may change a method of synchronizing information in the existing Web service environment.

As another example of the related art, the following has been proposed in which, when systems use different data formats, the data is converted to be transmitted to other systems. However, this structure performs only the conversion of data formats, but does not synchronize data of the user data provider with data of the user data consumer during the change of data.

### DISCLOSURE OF INVENTION

### Technical Problem

The invention is designed to solve the above problems, and an object of the invention is to provide a data synchronizing system and method using an XRI data link that consistently represents user data information and system information in XRIs, and represents information related to data update as a data link, thereby easily reflecting a data update to a user data consumer when data of a user data provider is changed.

### Technical Solution

According to an aspect of the invention, there is provided a data synchronizing system using an XRI data link. The system includes: a user data provider that provides users with data; a user data consumer that consumes user data provided by the user data provider; and an XRI resolver that analyzes XRI identifiers received from the user data provider or the user data consumer and provides metadata related to the XRI identifiers. The user data provider uses the metadata related to the XRI identifiers to instruct the user data consumer to update data.

The XRI resolver may include: a metadata registration module that receives and processes a metadata registration request from the user data provider or the user data consumer; and a metadata analyzing module that receives and processes a metadata analysis request from the user data provider or the user data consumer.

The user data provider may include: a data synchronizing module that requests the XRI resolver to transmit the metadata of the user data consumer when its own data is updated, and uses the metadata received from the XRI resolver to transmit information on the updated data to the user data consumer.

The user data provider may include: a metadata registration and search module that registers the metadata of the user data provider in the XRI resolver; and a data link management module that manages synchronization data in the user data provider.

The user data consumer may include: a data synchronizing module that receives information on the updated data from the user data provider, and performs data synchronization on the basis of the received data information.

According to another aspect of the invention, there is provided an XRI resolver that is connected to a user data provider and a user data consumer over a network, stores and manages metadata of the user data provider and the user data consumer, analyzes XRI identifiers included in the metadata received from the user data provider or the user data consumer, and provides the metadata related to the XRI identifiers to the user data provider or the user data consumer.

### Advantageous Effects

According to the invention, it is possible to facilitate data synchronization in an application program by providing a data synchronizing function, which has been provided in the form of a Web service, through an XRI data link, and thus it is possible to improve the efficiency of a system.

### BRIEF DESCRIPTION OF THE DRAWINGS

FIG. 1 is a diagram schematically illustrating the structure of a network environment that synchronizes data using an XRI data link according to the invention.

FIG. 2 is a diagram schematically illustrating the structure of a user data provider and a user data consumer according to the invention.

FIG. 3 is a diagram schematically illustrating the structure of an XRI resolver according to the invention.

FIG. 4 is a diagram illustrating the states of a user data provider, a user data consumer, and an XRI resolver according to an exemplary embodiment of the invention.

FIG. 5 is a diagram illustrating an exemplary embodiment of the metadata of a system registered in the XRI resolver according to the invention.

FIG. 6 is a diagram illustrating an exemplary embodiment of the operation of a data synchronizing module of the user data provider according to the invention.

### BEST MODE FOR CARRYING OUT THE INVENTION

The invention provides a method of synchronizing a user data provider with a user data consumer during a change in user data, using, as data connection information, an XRI (extensible resource identifier), which has been developed to improve an URI in which a link is likely to be disestablished due to a change in organization or a change in server data.

The invention provides an XRI resolver that registers system metadata including information on data synchronizing service providing positions and URI system addresses of a user data provider and a user data consumer, and when the user data provider transmits an XRI identifier of the user data consumer, resolves the metadata of the user data consumer and transmits the metadata to the user data provider.

Hereinafter, exemplary embodiments of the invention will be described with reference to the accompanying drawings.

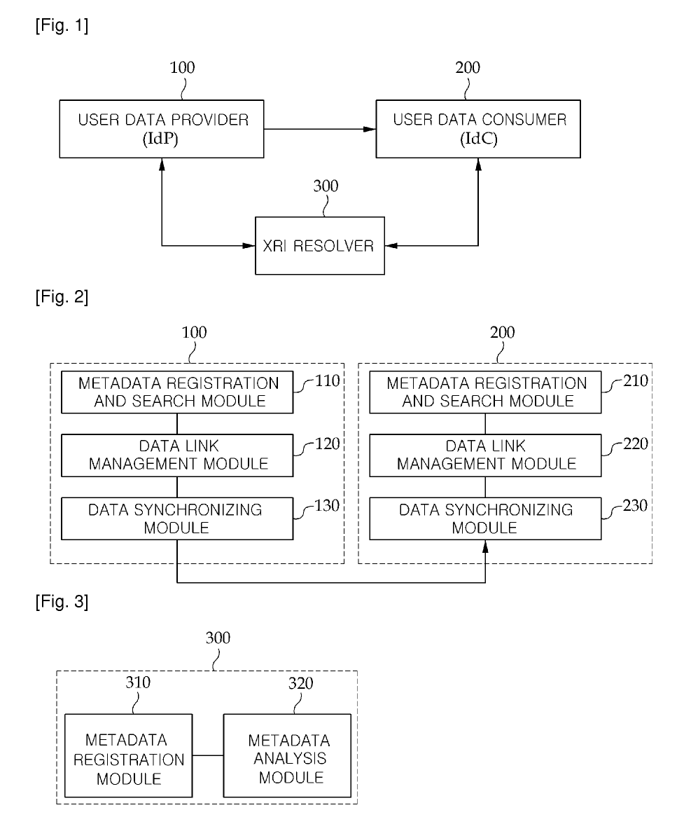

FIG. 1 is a diagram schematically illustrating the structure of a network environment that synchronizes data using an XRI data link according to an embodiment of the invention.

A user data provider (IdP) 100 provides users with data (for example, identity), and verifies the identity of an object. Preferably, the user data provider 100 is a server with public trust that provides users with identities. A user data consumer (IdC) 200 consumes user data provided by the user data provider 100, and an Internet book store is exemplified as the user data consumer.

An XRI resolver 300 stores and manages metadata of the user data provider 100 and the user data consumer 200.

The term metadata generally means data about data, that is, data describing the attributes of information resources. That is, the term metadata does not indicate data to be actually stored (for example, video, audio, and text), but indicates data for providing information that is directly or indirectly related to the data to be actually stored. The metadata makes it possible for the user to easily and rapidly check and search data that the user wants to use.

FIG. 2 is a diagram schematically illustrating the structure of the user data provider and the user data consumer according to the invention.

The user data provider 100 and the user data consumer 200 according to the invention include metadata registration and search modules 110 and 210, data link management modules 120 and 220, and data synchronizing modules 130 and 230, respectively.

The metadata registration and search module 110 registers metadata of the user data provider 100, the user data consumer 200 in the XRI resolver 300.

The data link management module 120 manages synchronization data in the user data provider 100 and the user data consumer 200.

When data in the user data provider 100 is updated, the data synchronizing module 130 of the user data provider 100 requests the XRI resolver 300 to transmit the metadata of the user data consumer 200, and uses the metadata received from the XRI resolver to transmit information on the updated data to the user data consumer 200. After receiving the information, the data synchronizing module 230 of the user data consumer 200 receives the updated data, and performs data synchronization.

FIG. 3 is a diagram schematically illustrating the structure of the XRI resolver according to the invention.

The XRI resolver shown in FIG. 3 analyzes XRI identifiers received from the user data provider 100 and the user data consumer 200, and provides metadata related to the XRI identifiers. The XRI resolver includes a metadata registration module 210 and a metadata analyzing module 220.

The metadata registration module 210 processes metadata registration requests from the user data provider 100 and the user data consumer 200, and the metadata analyzing module 220 processes metadata analysis requests from the user data provider 100 and the user data consumer 200.

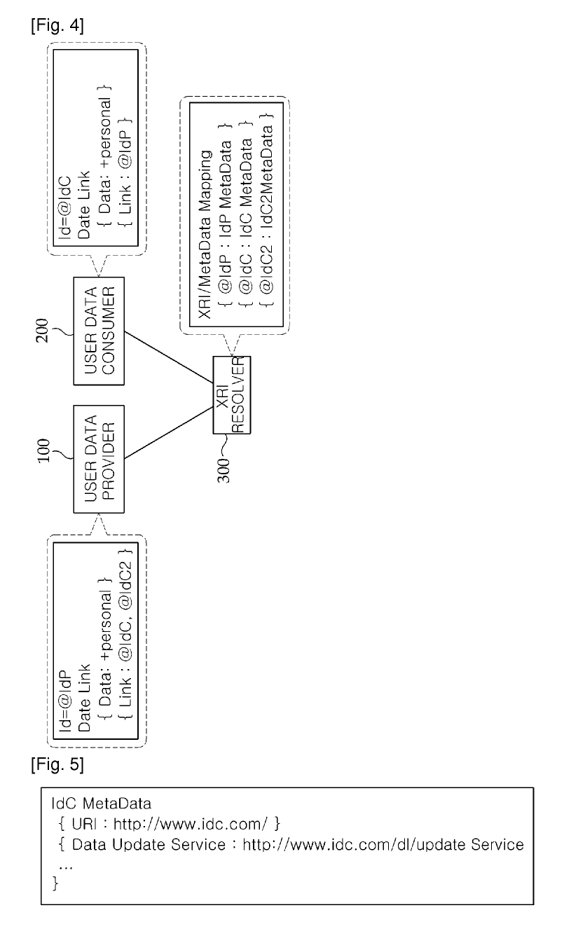

FIG. 4 is a diagram illustrating the states of a user data provider, a user data consumer, and an XRI resolver according to an exemplary embodiment of the invention.

FIG. 4 shows the states of components when the user data provider 100 and the user data consumer 200 register their own metadata in the XRI resolver 300 and personal identity information of users is set to be synchronized.

Referring to FIG. 4, in the user data provider 100, an XRI identifier (Id) thereof is “@IdP”, and personal identity data of the user is “+personal”. When the personal identity data “+personal” is changed, these information items indicate that an IdC having an identifier “@IdC” and an IdC having an identifier “@IdC2” are synchronized with each other.

Data described in the user data consumer 200 indicates that an XRI identifier thereof is “@IdC”, user ID data is “+personal”, the user data consumer 200 is connected to the user data provider 100 having an identifier “@IdP”.

Data described in the XRI resolver 300 indicates metadata of systems registered in the XRI resolver 300, specifically, metadata of systems having identifiers “@IdP, “@IdC”, and “@IdC2”.

FIG. 5 is a diagram illustrating an example of the metadata of a system registered in the XRI resolver according to the invention.

FIG. 5 shows an exemplary embodiment of the metadata of the system having the identifier “@IdC”. A URI address of the identifier “@IdC” is “http://www.idc.com/”, and the position of a data synchronizing service is “http://www.idc.com/dl/updateService”. If necessary, additional information may be registered in the metadata.

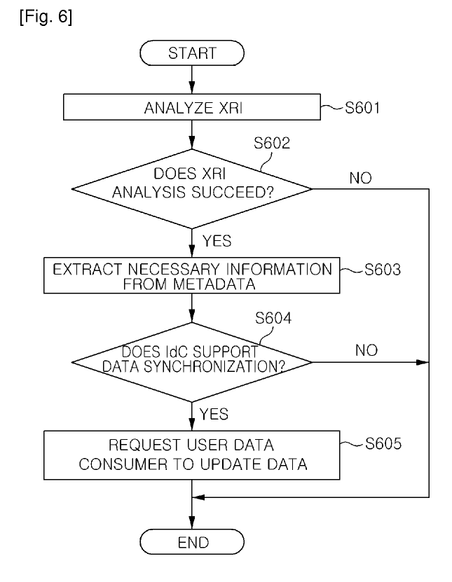

FIG. 6 is a flowchart illustrating an exemplary embodiment of the operation of a data synchronizing module of the user data provider according to the invention.

First, the XRI identifier of the user data consumer 200, which will be updated when data information is changed, is used to request the XRI resolver 300 to analyze metadata (S601). After the metadata is analyzed, it is examined whether the analysis of XRI succeeds (S602). As the result of the examination, if the analysis of XRI succeeds (YES in S602), necessary information is extracted from the metadata (S603). If the analysis of XRI fails (NO in S602), the process ends.

When necessary information is extracted from the metadata, it is examined whether the user data consumer 200 supports data synchronization (S604). If it is examined that the user data consumer 200 does not support data synchronization, the process ends (NO in S604). If not, that is, when the user data consumer 200 supports data synchronization, the user data consumer 200 is requested to update data (S605).

1. A data synchronizing system using an XRI data link, the system comprising:
a user data provider that provides users with data;
a user data consumer that consumes user data provided by the user data provider; and
an XRI resolver that analyzes XRI identifiers received from the user data provider or the user data consumer and provides metadata related to the XRI identifiers,
wherein the user data provider uses the metadata related to the XRI identifiers to instruct the user data consumer to update data.

2. The system of claim 1,
wherein the XRI resolver includes:
a metadata registration module that receives and processes a metadata registration request from the user data provider or the user data consumer.

3. The system of claim 1,
wherein the XRI resolver includes:
a metadata analyzing module that receives and processes a metadata analysis request from the user data provider or the user data consumer.

4. The system of claim 1,
wherein the user data provider includes:
a data synchronizing module that requests the XRI resolver to transmit the metadata of the user data consumer when its own data is updated, and uses the metadata received from the XRI resolver to transmit information on the updated data to the user data consumer.

5. The system of claim 4,
wherein the user data provider further includes:
a metadata registration and search module that registers the metadata of the user data provider in the XRI resolver.

6. The system of claim 4,
wherein the user data provider further includes:
a data link management module that manages data synchronized in the user data provider.

7. The system of claim 4,
wherein the user data consumer includes:
a data synchronizing module that receives information on the updated data from the user data provider, and performs data synchronization on the basis of the received data information.

8. An XRI resolver that is connected to a user data provider and a user data consumer over a network, stores and manages metadata of the user data provider and the user data consumer, analyzes XRI identifiers included in the metadata received from the user data provider or the user data consumer, and provides the metadata related to the XRI identifiers to the user data provider or the user data consumer.

9. The XRI resolver according to claim 8 comprising a metadata registration module that receives and processes a metadata registration request from the user data provider or the user data consumer.

10. The XRI resolver according to claim 8 comprising a metadata analyzing module that receives and processes a metadata analysis request from the user data provider or the user data consumer.

11. A data synchronizing method using an XRI data link, the method comprising:
allowing a user data provider and a user data consumer to register metadata in an XRI resolver;
allowing the XRI resolver to analyze XRI identifiers included in a metadata request received from the user data provider or the user data consumer;
allowing the XRI resolver to extract metadata related to the XRI identifiers; and
allowing the XRI resolver to provide the extracted metadata to the user data provider or the user data consumer.

12. The data synchronizing method of claim 11, further comprising:
allowing the user data provider to receive the extracted metadata from the XRI resolver; and
allowing the user data provider to transmit information on the updated data to the user data consumer using the received metadata.

13. The data synchronizing method of claim 12, further comprising:
allowing the user data consumer to receive the information on the updated data from the user data provider; and
performing data synchronization on the basis of the received data information.
